(19) United States
(12) Patent Application Publication
(10) Pub. No.: US 2008/0011164 A1
(43) Pub. Date: Jan. 17, 2008

(54) COOKING PAN

(76) Inventor: Mo B'ham, Leicester (GB)

Correspondence Address: CHERSKOV & FLAYNIK, THE CIVIC OPERA BUILDING, 20 NORTH WACKER DRIVE, SUITE 1447, CHICAGO, IL, 60606, US

(21) Appl. No.: 11/465,568

(22) Filed: Aug. 18, 2006

(30) Foreign Application Priority Data
Jul. 14, 2006 (CA) 2552036

(51) Int. Cl. A47J 37/12

(52) U.S. Cl. 99/403; 99/422; 99/404

(57) ABSTRACT

The invention provides a cooking pan with a handle that extends both outwardly and downwardly from the pan bowl to which it is connected. A pouring lip of the pan bowl is displaced substantially 180° from the handle. The pouring action is therefore a forward pouring action as opposed to the side pouring action of conventional saucepans. This has safety implications because the liquid (which may be hot or even boiling) is poured directly away from the user in a manner not possible with the conventional side position of a pouring lip. Because of the shape of the handle and the angle that it forms with the vertical, the pan is comfortable to hold and to use even with this unconventional position of pouring lip.

### CONTRACTUAL ORIGIN OF THE INVENTION

Not Applicable

### CLAIM FOR FOREIGN PRORITY

This application is related to, and claims priority under 35 USC §119 of Canadian Patent Application No. 2552036 filed Jul. 14, 2006, the complete subject matter of which is incorporated herein by reference in its entirety.

### BACKGROUND OF THE INVENTION

1. Field of the Invention

One or more embodiments of the present invention relate generally to cooking utensils. More specifically, one or more embodiments of the present invention relate to cooking pans, saucepans, frying pans and skillets (hereinafter generally referred to as “cooking pans” or “pans”).

2. Background of the Invention

Conventional cooking pans have a handle extending more or less horizontally out from the side of the pan body or pan bowl, although small variations from the horizontal are generally permitted for purely aesthetic design reasons. Some handles extend upwardly by a few degrees, and some extend downwardly by a few degrees, both variants being dependent on the shape and appearance of the handle.

Generally such conventional cooking pans, and in particular saucepans, have pouring lips provided as indented portions of the rim of the pan bowl. Such pouring lips are generally positioned substantially 90° to the right or left of the handle, permitting the contents of the pan to be poured to the right or to the left (generally depending on whether the user is right or left handed). Many such saucepans have two pouring lips, one on the left and one on the right so that they are equally suited for pouring in either direction.

The cooking pan of commonly owned U.S. Design Pat. Application No. 29/203,744 (Attorney Docket No. 0078/01515) and Canadian Design Registration No. 107673 has a very differently shaped handle. That handle comprises a proximal portion and a distal portion of which the proximal portion extends upwardly from its point of attachment to the pan bowl at an acute angle to the vertical, and the distal portion extends downwardly from the proximal portion at an acute angle to the vertical and is shaped to be gripped by a user in one hand. The preferred angle which the distal portion makes to the vertical in the above design of pan handle is substantially 42°, which is a much more natural angle for a user's wrist and which enables the user to lift the pan and its contents with much less effort and strain on the wrist than when lifting a conventional pan. In addition, the above design of pan handle is very elegant and has considerable eye-appeal.

When designing a cooking pan incorporating a handle according to commonly owned U.S. Design Pat. Application No. 29/203,744 (Attorney Docket No. 0078/01515) or Canadian Design Registration No. 107673 it would be natural to think only of the positioning of pouring lips in the conventional position of generally 90° to the right or to the left of the handle attachment point. This invention is based on the observation that the handle design of US Design Patent Application No commonly owned U.S. Design Pat. Application No. 29/203,744 (Attorney Docket No. 0078/01515) or of Canadian Design registration No. 107673 removes the constraint over where the pouring lip can be positioned relative to the handle, and makes it possible for the cooking pan to be designed to pour the contents directly away from the user, with a consequent increase in safety.

### SUMMARY OF THE INVENTION

An object of the invention is to provide a cooking pan that is safe to use without being tiring on the user and yet is appealing to the eye. One feature of this invention comprises a lip positioned generally opposite an upwardly and downwardly angled handle. An advantage of this arrangement is that it allows the contents of the pan to be poured directly away from the user (i.e., avoiding burning and splashing the user). The angled handle seems to naturally fit the user's hand, reducing stress and strain on the user's wrist, in addition to being eye-catching.

One or more embodiments of the present invention relate to a cooking pan comprising a pan lid, a handle and a single discrete pouring lip. The handle is attached to the pan bowl forming a point of attachment. The handle comprises proximal and distal portions, the proximal portion (at least a portion of which may be bifurcated) extends upwardly from the point of attachment to the pan bowl at an acute angle to a vertical. The distal portion extends downwardly from the proximal portion at an acute angle to the vertical. The pouring lip is formed in an upper edge of the pan bowl and is displaced substantially more than 90° from either direction from the point of attachment (i.e., substantially more than 90° but substantial less than 270°, generally ranging between 150° and 210° from the point of attachment, but more specifically 180°.

Another embodiment relates to a cooking pan comprising a pan bowl, a handle and a single discrete pouring lip. The handle is attached to the pan bowl forming a point of attachment, and comprises proximal and distal portions. The proximal portion has a bifurcated portion proximate the point of attachment and extends upwardly therefrom at an acute angle to a vertical. The distal portion extends downwardly from the proximal portion at an angle ranging between about 25° and 65° to the vertical and is adapted to be gripped by a user in one hand. The lip is formed in an upper edge of the pan bowl substantially 180° from the point of attachment.

Still another embodiment relates to a combination of a cooking pan and lid, the pan comprising a pan bowl, a handle and a single discrete pouring lip, while the lid comprises a closed end or top portion and a flange. The handle is attached to the pan bowl, where the handle comprises proximal and distal portions. The proximal portion extends upwardly from a point of attachment to the pan bowl at an acute angle to a vertical, and the distal portion extends downwardly from the proximal portion at an acute angle to the vertical and shaped to be gripped by a user in one hand. The lip is formed in an upper edge of the pan bowl and displaced substantially 180° from the point of attachment. The flange depends from a circular periphery of the closed end or top portion of the lid and is sized to fit inside an upper edge of the pan bowl forming a friction fit therewith. The depending flange has a depth or length sufficient to reach a bottom of the pouring lip and defines a plurality of apertures adapted to align with the pouring lip enabling straining solid material in the cooking pan when liquid is poured away over from the pouring lip.

Embodiments are contemplated in which at least a portion of the proximal portion is bifurcated. Other embodiments comprise the depending flange defining one or more zones of apertures, where each zone has one or more apertures.

Embodiments of the invention are based on an appreciation that a safer method of pouring can be established when using a pan with a handle shaped generally as shown in commonly owned U.S. Design Pat. Application Serial No. 29/203744 (Attorney Docket No. 0078/01515) and Canadian Design Registration No. 107673, each of which is incorporated herein by reference in its entirety. The shape of the handle enables the liquid to be poured from the pan bowl, not to the left or the right, but directly away from the user. The invention accordingly provides, in such a pan, a single discrete pouring lip formed in an upper edge of the pan bowl, the pouring lip being displaced substantially 180° from the point of attachment of the handle to the pan bowl.

The positioning of a single discrete pouring lip diametrically opposite the handle not only has safety implications; it has been found surprisingly that, even though this positioning is unique and even counter-intuitive, it provides for a much easier pouring action. The ease of pouring is maintained over a range of angles that the distal portion of the handle forms with the vertical.

The angle the distal portion of the handle forms with the vertical ranges generally between about 25° and 65°, advantageously between about 35° and 55°, but preferably ranges between about 40° and to 50°. It has been found that, in one embodiment, the optimum angle for the majority of users is about 42° to the vertical, which is a more natural angle for a user's wrist, enabling the user to lift the pan and its contents with less effort and strain on the wrist than when lifting a conventional pan. In addition, the above design is elegant and has considerable eye-appeal.

The cooking pan according to at least one embodiment of the invention may be unlidded or may be provided with a cooking lid. Preferably that lid has a flange depending from a circular periphery of the lid and sized to fit inside the upper edge of the pan bowl, forming a friction fit therewith. The depending flange has a depth sufficient to reach the bottom of the pouring lip, the depending flange being provided with one, two or more apertures adapted to align with the pouring lip, permitting the straining of solid material in the pan when liquid is being poured away from or over the pouring lip.

With such a pan and lid combination, the liquid in the pan can be safely poured in a direction more or less directly away from the user, while the cooked contents of the pan are retained by the straining action of the apertured lid flange. The depth of the flange should be sufficient to retain the lid on the pan during pouring, and, just as with the pouring action itself, the handle shape contributes significantly to the interoperability of the pan and straining lid. With a conventional pan having a more or less horizontal handle and side-pouring lips, it would be possible to tip the pan through too great an angle during pouring such that the lid falls off the pan and the solid contents of the pan are lost. The particular shape of handle and pan according to at least one embodiment of invention actually limits the pouring angle which may comfortable be achieved, so that the risk of losing the lid by turning the pan through too great a pouring angle is greatly diminished.

### DESCRIPTION OF THE DRAWING

Embodiments together with the above and other objects and advantages may best be understood from the following detailed description of the embodiments illustrated in the drawings, wherein:

FIG. 1 depicts a side perspective view of a pan and lid combination in accordance with one embodiment of the invention, the lid being shown raised above the pan bowl;

FIG. 2 depicts a top plan view of the pan and lid combination of FIG. 1;

FIG. 3 depicts another side perspective view of the pan and lid combination of FIG. 1, with the lid in place on the pan bowl;

FIG. 4 depicts a bottom plan view of the pan and lid combination of FIG. 1; and

FIG. 5 depicts a perspective view of another embodiment of a pan in accordance with one embodiment of the invention.

### DETAILED DESCRIPTION OF THE INVENTION

One embodiment of the present invention comprises cooking utensils. More specifically, one or more embodiments of the present invention relate to cooking pans that enable a user to pour the contents of the cooking pan directly away from the user. This cooking pan is easy to hold and use, in addition to being elegant and eye-appealing.

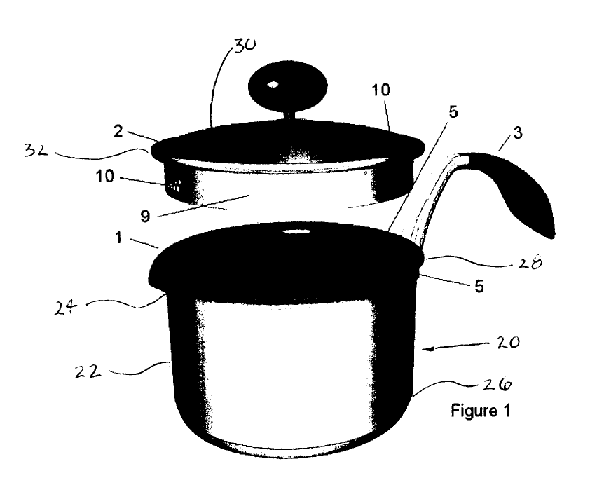

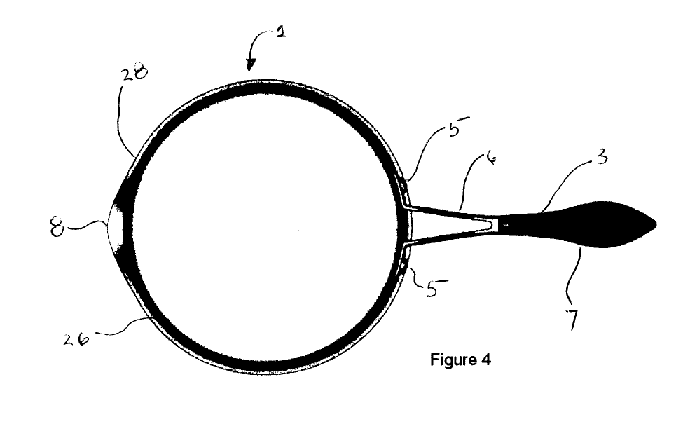

Referring to FIGS. 1, 2, 3 and 4, a pan 1 in combination with a lid 2 is illustrated. The pan 1 has a housing 20 having a longitudinal surface 22 extending between a first open end 24 and a second closed end 26 opposite the first open end 24. In at least one embodiment, first open end 24 has an upper edge 28 running around a periphery thereof.

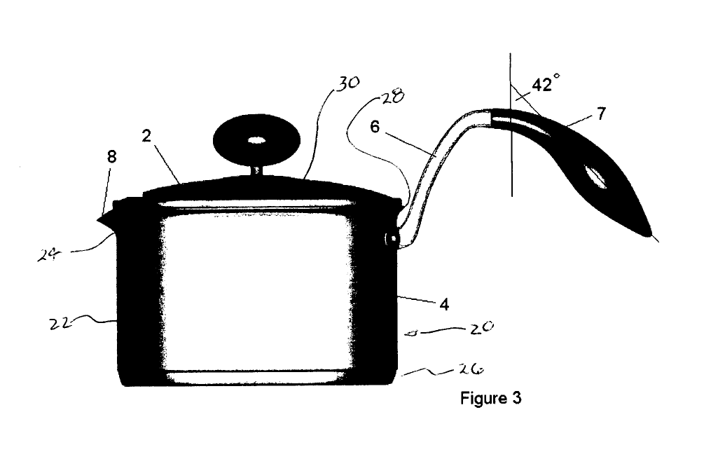

The pan 1 has a handle 3 removably or non-removably attached to the pan bowl 4. In one embodiment, one or more rivets 5 attach the handle 3 to the pan bowl 4. Clearly other removable and non-removable attachment methods, such as a welding, ferrule mountings and screw mountings for example, are also contemplated. In at least one embodiment, the handle 3 comprises a proximal portion 6 and a distal portion 7 as illustrated in FIG. 3. The proximal portion 6 rises upwardly from the pan bowl at an acute angle to the vertical, and then curves round in a smooth arc to the downwardly angled distal portion 7. In at least one embodiment, distal portion 7 is shaped to permit a comfortable grip in one hand by the user. Other handle shapes, ribbed handles for example, are also contemplated.

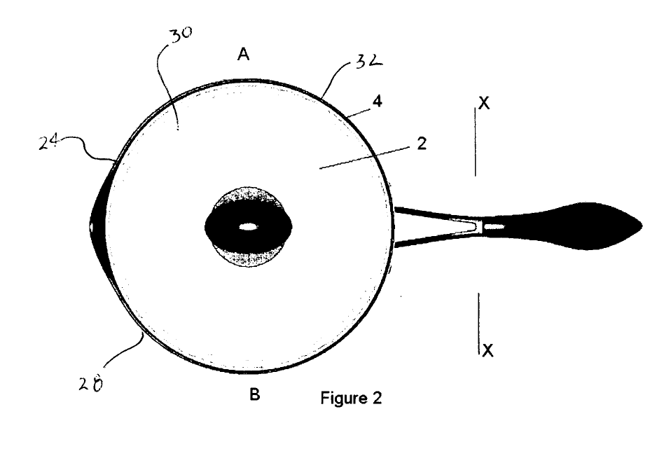

In at least one embodiment, the proximal portion 6 of the handle 3 is bifurcated to minimize heat transference from the pan bowl 4 to the distal portion 7 (best viewed in FIG. 2). One important feature of the invention is the acute angle the distal portion 7 forms with respect to the vertical as illustrated in FIG. 3. In one embodiment, the angle the distal portion 7 forms with the vertical ranges generally between about 25° and 65°, advantageously between about 35° and 55°, and more specifically between about 40° and 50°. It has been found that, in one embodiment, the optimum angle for the majority of users is a 42° with respect to the vertical, which is a more natural angle for a user's wrist, enabling the user to lift the pan and its contents with effort and strain on the wrist than when lifting a conventional pan.

The pan bowl 4 includes a pouring lip 8 over which liquid contents of the pan can be poured. Normally pouring lips would be provided at 90° to the line of the handle, in the positions indicated A and B in FIG. 2; but according to at least one embodiment of the invention, a single discrete pouring lip 8 is formed in upper edge 28 substantially more than 90° from either direction from the point of attachment (i.e., substantially more than 90° but substantial less than 270°, generally ranging between 150° and 210° from the point of attachment, but more specifically 180° (i.e., generally diametrically opposite to the handle 3). This tip, in conjunction with the shape of the handle 3, makes for an unexpectedly easy and safe pouring action. The safety is assured by the fact that the pan pours away from the body of the user, so that there is less risk of scalding from hot liquids. The ease of use is more unexpected and surprising, and can be explained by the fact that the pouring action is a more natural action places less strain on the wrist and enabling the user to lift and pour greater weights of liquids without muscular or joint strain at the wrist.

The lid 2 is illustrated in FIG. 1 and comprises a conventional pan lid or curved, closed end or top portion 30 with a deep flange 9 depending from a circular periphery 32 thereof. In one embodiment, the flange 9 fits closely in use in the pan bowl 4, forming a friction fit therewith. The flange 9 is deep or long enough to extend down to or past the bottom of the lip 8. That depth serves to retain the lid 2 on the pan 1 over a range of pouring angles. In at least one embodiment, the lid 2 defines two zones of two or more perforations or apertures 10, diametrically opposite one another as shown in FIG. 1. It is contemplated that each zone of perforations 10 may have the same or different number of perforations. Further, the perforations in each zone may be the same or different sizes (one larger than the other), the same or different shapes or some combination of any of these.

Alternatively a single zone of perforations may be defined; or two or more such zones may be offset from one another at a different angle; or the entire periphery of the deep flange 9 may be perforated. Two discrete zones of perforations 10 in the lid 2 in respective zones may include perforations of different diameters or sizes, permitting fine and coarse straining. Similar straining lids are available, but the particular advantage of using a straining lid such as illustrated in conjunction with embodiments of the pan 1 is that the shape of the handle of the pan makes it unlikely that the user will rotate the pan through a pouring angle so great that the lid falls away with the poured liquid. A conventional pan having a horizontally extending handle is normally poured by rotating the pan bowl around the axis of the handle, which makes it possible to turn the pan through excessive pouring angles, even to the extent of complete inversion. The pouring action of a pan 1 according to at least one embodiment of the invention involves rotating the pan 1 around line X-X illustrated in FIG. 2. It would be unnatural for a user to rotate the pan 1 about line X-X until the lid fell off.

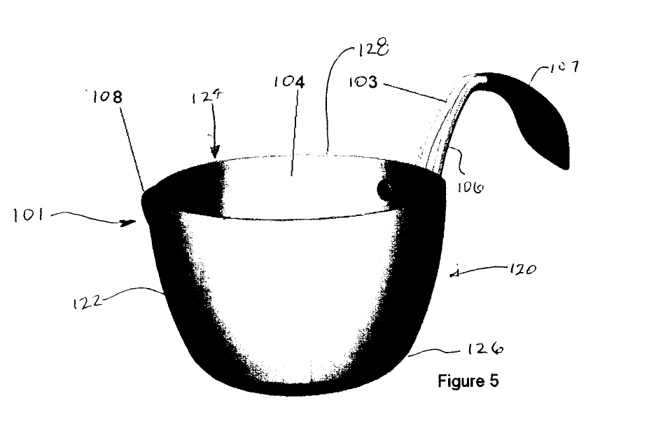

FIG. 5 illustrates a second embodiment of a pan 101 similar to that provided previously. In this embodiment, the pan bowl 104 shape is different, as is the shape of the pouring lip 108. More specifically longitudinally extending surface 122 is tapered moving from first open end 124 and upper edge 128 towards second closed end 126 (i.e., frustoconical in appearance) while pouring lip 108 is more rounded. Although the tapered, frustonconical or rounded shapes and sides are discussed, other shapes are contemplated. However, handle 103 having proximal and distal potions 106 and 107 arr similar to that provided previously.

It should be appreciated that the upward direction of the proximate portion 6, 106 of the handle 3, 103, makes the handle suitable for use with pans with low bodies, such as frying pans or skillets. Such pans, which do not normally incorporate pouring lips 8, 108 are advantageously provided with pouring lips 8, 108 positioned according to the invention.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

The embodiment of the invention in which an exclusive property or privilege is claimed is defined as follows:

1. A cooking pan comprising:
a) a pan bowl;
b) a handle attached to said pan bowl forming a point of attachment, said handle comprising proximal and distal portions, said proximal portion extending upwardly from said point of attachment to said pan bowl at an acute angle to a vertical, and said distal portion extending downwardly from said proximal portion at an acute angle to said vertical; and
c) a single discrete pouring lip formed in an upper edge of said pan bowl, said pouring lip being displaced more than 90° from said point of attachment.

2. The cooking pan of claim 1 wherein at least a portion of said proximal portion is bifurcated.

3. The cooking pan of claim 1 wherein said distal portion of said handle extends downwardly from said proximal portion at an angle ranging between about 25° and 65° to said vertical.

4. The cooking pan of claim 1 wherein said distal portion of said handle extends downwardly from said proximal portion at an angle ranging between about 35° and 55° to said vertical.

5. The cooking pan of claim 1 wherein said distal portion of said handle extends downwardly from said proximal portion at an angle ranging between about 40° and 50° to said vertical.

6. The cooking pan of claim 1 wherein said distal portion of said handle extends downwardly from said proximal portion at a 42° angle to said vertical.

7. The cooking pan of claim 1 wherein said handle is adapted to be gripped by a user in one hand.

8. The cooking pan of claim 1 further comprising a lid, said lid comprising:
a) a closed top portion; and
b) a flange depending from a circular periphery of said closed top portion and sized to fit inside an upper edge of said pan bowl forming a friction fit therewith, said depending flange having a depth sufficient to reach a bottom of said pouring lip, said depending flange defining at least two apertures adapted to align with said pouring lip enabling straining of a solid material in the cooking pan when liquid is poured away from said pouring lip.

9. The cooking pan of claim 8 wherein said depending flange defines at least two separate zones of apertures.

10. The cooking pan of claim 9 wherein said apertures in said zones are different sizes.

11. A cooking pan comprising:
a) a pan bowl;
b) a handle attached to said pan bowl forming a point of attachment, said handle comprising proximal and distal portions, said proximal portion having a bifurcated portion proximate said point of attachment and extending upwardly therefrom at an acute angle to a vertical, and said distal portion extending downwardly from said proximal portion at an angle ranging between about 25° and 65° to said vertical and adapted to be gripped by a user in one hand; and
c) a single discrete pouring lip formed in an upper edge of said pan bowl, said pouring lip being displaced substantially 180° from said point of attachment.

12. The cooking pan of claim 11 wherein said distal portion of said handle extends downwardly from said proximal portion at a 42° angle to said vertical.

13. The cooking pan of claim 12 further comprising a lid, said lid comprising:
a) a closed top portion; and
b) a flange depending from a circular periphery of said closed top portion and sized to fit inside an upper edge of said pan bowl forming a friction fit therewith, said depending flange having a depth sufficient to reach a bottom of said pouring lip, and said depending flange defining at least two apertures adapted to align with said pouring lip enabling straining of a solid material in the cooking pan when liquid is poured away from said pouring lip.

14. A combination of a cooking pan and lid, the pan comprising:
a) a pan bowl;
b) a handle attached to said pan bowl, said handle comprising proximal and distal portions, said proximal portion extending upwardly from a point of attachment to said pan bowl at an acute angle to a vertical, and said distal portion extending downwardly from said proximal portion at an acute angle to said vertical; and
c) a single discrete pouring lip formed in an upper edge of said pan bowl, said pouring lip being displaced substantially 180° from said point of attachment; and
the lid comprising:
a) a closed top portion;
b) a flange depending from a circular periphery of said closed top portion and sized to fit inside an upper edge of said pan bowl forming a friction fit therewith, said depending flange having a depth sufficient to reach a bottom of said pouring lip, said depending flange defining a plurality of apertures adapted to align with said pouring lip enabling straining of a solid material in the cooking pan when liquid is poured away from said pouring lip.

15. The cooking pan of claim 14 wherein at least a portion said proximate portion is bifurcated.

16. The cooking pan of claim 14 wherein the distal portion of said handle extends downwardly from said proximal portion at an angle ranging between about 25° and 65° to said vertical.

17. The cooking pan of claim 16 wherein said distal portion of said handle extends downwardly from said proximal portion at an angle ranging between about 35° and 55° to said vertical.

18. The cooking pan of claim 17 wherein said distal portion of said handle extends downwardly from said proximal portion at an angle ranging between about 40° and 50° to said vertical.

19. The cooking pan of claim 18 wherein said distal portion of said handle extends downwardly from said proximal portion at a 42° angle to said vertical.

20. The cooking pan of claim 14 wherein said flange defines at least two separate zones of apertures, each said zone containing a plurality of apertures.
